(19) United States
(12) Patent Application Publication
(10) Pub. No.: US 2026/0091342 A1
(43) Pub. Date: Apr. 2, 2026

(54) A COMPOSITION FOR REMOVING CHEMICALS FROM PLANT PRODUCTS AND A METHOD OF MANUFACTURING THEREOF

(71) Applicant: INTEGRA SPECIALTY PRODUCTS, INC., Las Vegas, NV (US)

(72) Inventors: Sammie Joe Glorioso, Ridgeland, MS (US); Ben Blankenhorn, Las Vegas, NV (US)

(21) Appl. No.: 19/345,272

(22) Filed: Sep. 30, 2025

Related U.S. Application Data
(60) Provisional application No. 63/701,481, filed on Sep. 30, 2024.

(51) Int. Cl. B01D 53/04; A23B 7/152; B01J 20/12; B01J 20/18; B01J 20/20; B01J 20/28

(52) U.S. Cl. CPC B01D 53/0415; A23B 7/152; B01J 20/12; B01J 20/18; B01J 20/20; B01J 20/2805; B01D 2253/102; B01D 2253/108; B01D 2253/11; B01D 2257/406; B01D 2257/7025

(57) ABSTRACT

A chemical removing element including a sealed sachet containing a chemical removing composition, the chemical removing composition including carbon and zeolite, wherein the chemical removing composition is configured to remove ammonia-like chemicals having one or more covalent bonds among smaller numbers of atoms from an environment surrounding the chemical removing element.

### CROSS REFERENCE TO RELATED APPLICATIONS

This U.S. application claims priority to and the benefit of U.S. Provisional Patent Application No. 63/701,481, filed on Sep. 30, 2024.

### BACKGROUND

### 1. Field

The present disclosure relates generally to a composition for removing ammonia and/or related chemicals. The present disclosure also relates generally to a composition for removing ammonia and/or related chemicals from tobacco or other leaf or plant products and a method of manufacturing thereof.

### 2. Description of the Related Art

Tobacco used in various tobacco products such as cigarettes and premium cigars, may be fermented after harvest in large stacks or bails indoors. During the fermentation process, ammonia and related chemicals may be created in high levels. This can make it difficult, or even hazardous, for workers to work in proximity with fermenting tobacco. Moreover, some residual ammonia and related chemicals may remain in tobacco when the tobacco is rolled or packaged into the tobacco product. The residual amounts of ammonia or related chemicals in the tobacco can be detected or tasted by the consumer when the tobacco product is consumed (e.g., when the tobacco product is smoked). This is normally experienced by the tobacco user as an added harshness to the taste, which is often undesirable.

The issue of ammonia and related chemicals production and residual retention may also be experienced with other fermented leaf or plant products that may be consumed. For example, many forms of tea are fermented before use. There may also be other chemicals produced during fermentation, such as alcohols and/or ketones, that can adversely impact upon the experience of those consuming fermented leaf or plant products. Other situations may also benefit from chemical removal from the environment. For example, many fruits and vegetables when shipped or stored could benefit from a slowing of the ripening process so as not to become overly ripe before potential consumption. Ripening can be caused by exposure to ethylene (e.g., ethylene gas). Thus, removal of ethylene gas from an environment where fruits and/or vegetables are being stored or transported may be beneficial.

### SUMMARY

Aspects of embodiments of the present disclosure are directed toward a composition for removing ammonia and/or related chemicals from tobacco or other leaf or plant products and a method of manufacturing thereof.

According to one or more embodiments of the present disclosure, a chemical removing element includes a sealed sachet containing a chemical removing composition, the chemical removing composition including carbon and zeolite, wherein the chemical removing composition is configured to remove ammonia-like chemicals having one or more covalent bonds among smaller numbers of atoms from an environment surrounding the chemical removing element.

According to one or more embodiments, the chemical removing composition includes about 50% by weight of the chemical removing composition is carbon and about 50% by weight of the chemical removing composition is zeolite.

According to one or more embodiments, the chemical removing composition includes about 60% by weight of the chemical removing composition is carbon and about 40% by weight of the chemical removing composition is zeolite.

According to one or more embodiments, the carbon includes coal-based powder.

According to one or more embodiments, the zeolite includes Natural Sodium Chabazite (AZLB-Na).

According to one or more embodiments, the chemical it is configured to remove includes at least one of ammonia, hydrocarbons having 1 to 3 carbon atoms, ketones, or alcohols.

According to one or more embodiments, the chemical it is configured to remove includes ethylene.

According to one or more embodiments of the present disclosure, a chemical removing element includes a sealed sachet containing a chemical removing composition, the chemical removing composition including carbon and sodium bentonite clay, wherein the chemical removing composition is configured to remove ammonia-like chemicals having one or more covalent bonds among smaller numbers of atoms from an environment surrounding the chemical removing element.

According to one or more embodiments, the chemical removing composition includes about 50% by weight of the chemical removing composition is carbon and about 50% by weight of the chemical removing composition is sodium bentonite clay.

According to one or more embodiments, the chemical removing composition includes about 60% by weight of the chemical removing composition is carbon and about 40% by weight of the chemical removing composition is sodium bentonite clay.

According to one or more embodiments, the carbon includes coal-based powder.

According to one or more embodiments, the chemical it is configured to remove includes at least one of ammonia, hydrocarbons having 1 to 3 carbon atoms, ketones, or alcohols.

According to one or more embodiments, the chemical it is configured to remove includes ethylene.

According to one or more embodiments of the present disclosure, a system for removing chemicals includes: a chemical removing element including a sealed sachet containing a chemical removing composition; and a plant product, wherein the chemical removing composition is configured to remove ammonia-like chemicals having one or more covalent bonds among smaller numbers of atoms from an environment surrounding the chemical removing element.

According to one or more embodiments, the chemical removing composition includes carbon and zeolite.

According to one or more embodiments, the chemical removing composition includes about 50% by weight of the chemical removing composition is carbon and about 50% by weight of the chemical removing composition is zeolite.

According to one or more embodiments, the chemical removing composition includes about 60% by weight of the chemical removing composition is carbon and about 40% by weight of the chemical removing composition is zeolite.

According to one or more embodiments, the carbon includes coal-based powder.

According to one or more embodiments, the zeolite includes Natural Sodium Chabazite (AZLB-Na).

According to one or more embodiments, the chemical removing composition includes carbon and sodium bentonite clay.

According to one or more embodiments, the chemical removing composition includes about 50% by weight of the chemical removing composition is carbon and about 50% by weight of the chemical removing composition is sodium bentonite clay.

According to one or more embodiments, the chemical removing composition includes about 60% by weight of the chemical removing composition is carbon and about 40% by weight of the chemical removing composition is sodium bentonite clay.

According to one or more embodiments, the carbon includes coal-based powder.

According to one or more embodiments, the plant product includes a tobacco product.

According to one or more embodiments, the chemical it is configured to remove includes at least one of ammonia, hydrocarbons having 1 to 3 carbon atoms, ketones, or alcohols.

According to one or more embodiments, the chemical it is configured to remove includes ethylene.

According to one or more embodiments of the present disclosure, a method for forming a chemical removing element includes: preparing a chemical removing composition; adding the chemical removing composition to a sachet; and sealing the sachet, wherein the chemical removing composition is configured to remove chemicals from an environment surrounding the chemical removing element, and wherein the chemical the composition is configured to remove includes at least one of ammonia, hydrocarbons having 1 to 3 carbon atoms, ketones, or alcohols.

According to one or more embodiments, the chemical removing composition includes carbon and zeolite.

According to one or more embodiments, the chemical removing composition includes about 50% by weight of the chemical removing composition is carbon and about 50% by weight of the chemical removing composition is zeolite.

According to one or more embodiments, the chemical removing composition includes about 60% by weight of the chemical removing composition is carbon and about 40% by weight of the chemical removing composition is zeolite.

According to one or more embodiments, the carbon includes coal-based powder.

According to one or more embodiments, the zeolite includes Natural Sodium Chabazite (AZLB-Na).

According to one or more embodiments, the chemical removing composition includes carbon and sodium bentonite clay.

According to one or more embodiments, the chemical removing composition includes about 50% by weight of the chemical removing composition is carbon and about 50% by weight of the chemical removing composition is sodium bentonite clay.

According to one or more embodiments, the chemical removing composition includes about 60% by weight of the chemical removing composition is carbon and about 40% by weight of the chemical removing composition is sodium bentonite clay.

According to one or more embodiments, the carbon includes coal-based powder.

According to one or more embodiments, the chemical the composition is configured to remove includes ethylene.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart showing a method for manufacturing packages with a composition for removing ammonia or related chemicals from tobacco or other leaf or plant products, in accordance with one or more embodiments of the present disclosure;

FIG. 2 is a sachet that may be used to contain an ammonia or related chemical removing composition;

FIG. 3 is a strip package that may be used to contain an ammonia or related chemical removing composition for use in larger volume applications;

FIG. 4 is a storage container including a tobacco or other leaf or plant product and an ammonia or related chemicals removing element, in accordance with one or more embodiments of the present disclosure; and

FIG. 5 is a table of ammonia removal measurements of an enclosed environment containing an ammonia removing composition as measured in Examples 1-5, in accordance with example embodiments of the disclosure.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

In the following description, for the purposes of explanation, numerous specific details are set forth to provide a thorough understanding of various embodiments. It is apparent, however, that various embodiments may be practiced without these specific details or with one or more equivalent arrangements.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present disclosure are described below.

The present disclosure is directed to one or more embodiments of a composition for removing ammonia (NH₃) or related chemicals from an environment (e.g., ammonia removing composition). In one or more embodiments, the composition may be used to remove ammonia from tobacco used in tobacco products. The ammonia removing composition may remove ammonia via absorption, adsorption, or other removal processes. The ammonia removing composition may be contained within a package (e.g., a sachet or other container) to form an ammonia removing element. In one or more embodiments, the composition may include a mixture (e.g., a powder mixture) of carbon and zeolite. In one or more embodiments, the composition may include a mixture of carbon and sodium bentonite clay (e.g., NA clay).

In one or more embodiments, the composition may be used to remove other chemicals in addition to ammonia. For example, the composition may also be used to remove alcohols and/or ketones that may be produced during fermentation or other processing. In yet another embodiment, the composition may be used to remove ethylene (e.g., ethylene gas) from an environment to slow down the ripening of fruits and vegetables in transport or storage.

In one or more embodiments, the carbon may include a coal-based powder activated with high temperature steam (e.g., CAR325 (Jacobi, lot. 8022120871)). The carbon may have a high removal (e.g., adsorption) capacity and can retain certain types of molecules in the carbon porosity.

In one or more embodiments, the zeolite may include Natural Sodium Chabazite (AZLB-Na). The zeolite can improve the efficiency of the removal (e.g., adsorption) of the ammonia or related chemicals by acting as a catalyst. For example, the pore size and pH of zeolite can help improve the efficiency of the removal (e.g., adsorption) of the ammonia or related chemicals.

In one or more embodiments, about 45% to about 65% by weight of the composition may include carbon and about 45% to about 65% by weight of the composition may include zeolite. In one or more embodiments, about 50% by weight of the composition may include carbon and about 50% by weight of the composition may include zeolite. In one or more embodiments, about 60% by weight of the composition may include carbon and about 40% by weight of the composition may include zeolite. But the amounts of the carbon and zeolite in the ammonia removing composition are not limited to the ranges disclosed herein.

In one or more embodiments, about 45% to about 65% by weight of the composition may include carbon and about 45% to about 65% by weight of the composition may include NA clay or bentonite. In one or more embodiments, about 50% by weight of the composition may include carbon and about 50% by weight of the composition may include NA clay. In one or more embodiments, about 60% by weight of the composition may include carbon and about 40% by weight of the composition may include NA clay. But the amounts of the carbon and NA clay in the ammonia removing composition are not limited to the ranges disclosed herein.

In one or more embodiments, the package may include Tyvek. For example, the Tyvek may include NOOX Tyvek (e.g., TYCP9.5-8NOOX used for Oxygen Scavengers). The package may also include MACTEX, Kraft, and/or Lucky Moon materials. These materials may be used in the form of a film that is used to construct all or a portion of the package for holding the removing composition. It should be understood that any material able to contain the removing composition while allowing adequate permeability of the chemicals to be removed may be appropriately employed in one or more embodiments.

In one or more embodiments, the ammonia removing element can be used to remove ammonia from tobacco used in tobacco products. The tobacco products may include cigars, cigarettes, or other tobacco products. For example, the tobacco products may be stored in a humidor, shipping container, or other storage container with the ammonia removing element. While the ammonia removing element is stored with the tobacco products, the ammonia removing composition can remove (e.g., adsorb or absorb) ammonia from the tobacco in the tobacco products, and reduce the concentration of the ammonia in the tobacco. The reduction of ammonia in the tobacco can improve the flavor of the tobacco products.

According to one or more embodiments, the ammonia removing elements can be manufactured using a packaging machine. In one or more embodiments, the carbon and zeolite may be blended before being added to a package (e.g., sachet or other container). The carbon and zeolite may be blended using a double auger machine or may be blended using a mixer (e.g., a ribbon blender). In one embodiment, the carbon and zeolite may be mixed in the ribbon blender for about 15 minutes. After the carbon and zeolite have been mixed, the mixture may be added to a container (e.g., a hopper) over a turntable. The hopper may then be used to deposit a measured amount of the mixture into a package, which may be positioned on the turntable.

In other embodiments, the carbon and zeolite each may be added (e.g., metered) individually (e.g., separate from each other) to the package. For example, the carbon may be on a first container (e.g., a first hopper) and the zeolite may be on a second container (e.g., a second hopper). The first hopper and the second hopper may be positioned over a turntable containing one or more packages (e.g., one or more sachets or other containers). The first hopper can be used to deposit a measured amount of the carbon into a package and the second hopper can be used to deposit a measured amount of the zeolite into the same package.

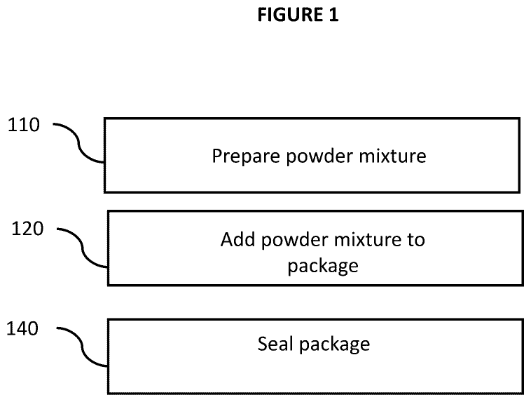

FIG. 1 is a flowchart showing a method for manufacturing a package (e.g., sachet or other container) containing an ammonia removing composition, in accordance with example embodiments of the disclosure. According to some example embodiments, the number and order of operations illustrated in FIG. 1 may vary. For example, according to some example embodiments, there may be fewer or additional operations, unless otherwise stated or implied to the contrary. Additionally, the order of the operations may vary, unless otherwise stated or implied to the contrary.

The method for manufacturing packages containing ammonia removing composition may begin with preparing a powder mixture in step 110. In one or more embodiments, the powder mixture may include carbon and zeolite. In one or more embodiments, about 45% to about 65% by weight of the composition may include carbon and about 45% to about 65% by weight of the composition may include zeolite. In one or more embodiments, about 50% by weight of the powder mixture may include carbon and about 50% by weight of the powder mixture may include zeolite. In one or more embodiments, about 60% by weight of the powder mixture may include carbon and about 40% by weight of the powder mixture may include zeolite.

The powder mixture may include carbon and NA clay or bentonite. In one or more embodiments, about 45% to about 65% by weight of the composition may include carbon and about 45% to about 65% by weight of the composition may include NA clay. In one or more embodiments, about 50% by weight of the powder mixture may include carbon and about 50% by weight of the powder mixture may include NA clay. In one or more embodiments, about 60% by weight of the powder mixture may include carbon and about 40% by weight of the powder mixture may include NA clay.

In step 120, the powder mixture may be added to empty packages. In embodiments, the powder mixture can be added to the empty packages using a container (e.g., a hopper) positioned over one or more turntables. For example, the powder mixture may be placed in the container while the empty packages are positioned on the turntables. The container can be configured to deposit a measured amount of the powder mixture into the packages positioned on the turntables.

Additionally, the components of the powder mixture may be added at various times. For example, the individual components of the powder mixture (e.g., carbon and zeolite or carbon and NA clay) may be added (e.g., metered) individually (e.g., separate from each other) to the package. In another example, the individual components (e.g., carbon and zeolite or carbon and NA clay) may be blended or mixed together before being added to the package. The individual components may be blended using a double auger machine or may be blended using a mixer (e.g., a ribbon blender). In one embodiment, the individual components may be mixed in the ribbon blender for about 15 minutes.

In another example, carbon and NA clay may be added (e.g., metered) individually (e.g., separate from each other) to the package.

In step 140, the package is sealed. In some embodiments, the packages may be sealed using a packaging machine.

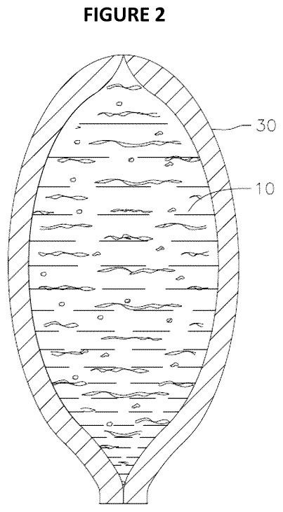

FIG. 2 shows an example of a sachet that may be used as a package for the chemical removing composition in applications where removal is to be from smaller volume containers, such as humidors. The composition is delivered to the interior of the sachet as described by the method above, and the sachet is then sealed. The sachet is formed from a film material such as Tyvek, or any one of the potential film materials noted above.

As shown in FIG. 2, the chemical removing composition 10 may be packaged within the sachet 30. In one or more embodiments, the sachet 30 may include a nonwoven fabric including polyethylene and/or polypropylene. As such, the sachet 30 may adhere to itself, and provide for a faster WVTR because no additional coating is needed. In one or more embodiments, the sachet 30 is sealed at a pressure (e.g., a predetermined pressure) that allows facing portions of the sachet 30 to seal to each other.

In one or more embodiments, the sachet 30 may include a nonwoven fabric including polyethylene and a polypropylene spunbound (PPSB) material. For example, a suitable nonwoven fabric is the MACTEX®203020 material (MACTEX® is a registered trademark of Mactex, Incorporated). In some embodiments, a material with 20 grams per square meter (GSM) polyethylene+30 GMS PPSB+20 GSM polyethylene may be utilized. In one or more embodiments, the sachet 30 may include Tyvek, Kraft, and/or Lucky Moon material.

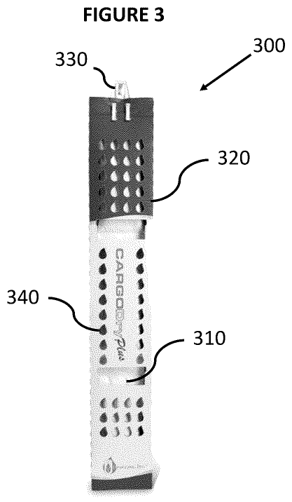

FIG. 3 shows an example of a strip package 300 that may be used as a package for the chemical removing composition in applications where removal is to be from larger volume environments, such as a fermentation room or a transport truck. The composition is delivered to the interior of an extended strip 310 at one end of the strip 310, and that end of the strip 310 is then sealed. The extended strip 310 is formed from a film material such as Tyvek, or any one of the potential film materials noted above. The extended strip 310 is then placed inside an outer protective package 320 made of paperboard or corrugated cardboard. The outer protective package 320 has a hanger 330 attached at one end of the package 320 to allow the package 320 to be placed in the environment. The walls of the outer protective package 320 help protect the internal strip 310, and help to support and hold it in an extended position so that the surface is sufficiently exposed to the environment. The outer protective package 320 also contains openings or perforations 340 along its length to ensure adequate airflow to the surface of the internal strip 310.

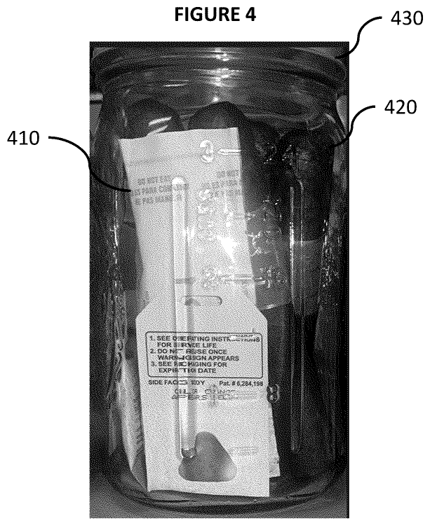

FIG. 4 is a storage container including a tobacco product and an ammonia removing element, in accordance with one or more embodiments of the present disclosure. As noted previously, another leaf or plant product may also be in the storage container. Further, the removing element may be selected to remove other chemicals in addition to or besides ammonia from the environment of the container.

As shown in FIG. 4, the ammonia removing element 410 and the tobacco product 420 are stored together inside a container 430. The ammonia removing element 410 may include a package containing an ammonia removing composition, such as a sachet. While the ammonia removing element 410 is stored with the tobacco product 420, the ammonia removing composition can remove (e.g., adsorb or absorb) ammonia from environment surrounding the tobacco in the tobacco product 420 and thereby reduce the concentration of the ammonia in the tobacco by increasing the diffusion of ammonia from the tobacco. The reduction of ammonia in the tobacco can improve the flavor of the tobacco product 420. A sensor or other detector may also be included in the container to visually display the removal of the ammonia or other chemical from the environment. The sensor or other detector may be used to show the amount of ammonia or other chemical that has been removed, and may also be used to show when the ammonia removing element needs to be replaced, replenished or otherwise reactivated.

As described through the present disclosure, the composition in the ammonia removing element may be used to remove ammonia from an environment, but the use of the composition is not limited thereto. For example, the adsorption process of ammonia by the composition is based, at least in part, by the size and configuration of the ammonia structure. That is, ammonia includes simple covalent bonds between a nitrogen atom and three hydrogen atoms. As such, the composition may also be used to remove other chemicals including similar chemical structures as ammonia (e.g., one or more covalent bonds among smaller numbers of atoms), which may include, but is not limited to, short hydrocarbon chains including 1 to 3 carbon atoms (e.g., ethylene), ketones (e.g., acetone), and alcohols (e.g., ethanol).

### Example 1

A package containing an ammonia removing composition was prepared according to the embodiments disclosed herein.

The ammonia removing composition was prepared as a powder mixture. The amount of the powder mixture was about 15 grams. The formulation of the powder mixture was about 50% carbon and about 50% zeolite.

The powder mixture was sealed within a MACTEX package.

A flask containing a measured amount of ammonia gas (NH₃) was prepared. The initial amount of ammonia gas in the flask was 723 mg (e.g., initial ammonia gas charge). The package containing the ammonia removing composition was inserted inside the flask. After one hour, an additional amount of 1446 mg of ammonia gas was inserted inside the flask (e.g., additional ammonia gas charge).

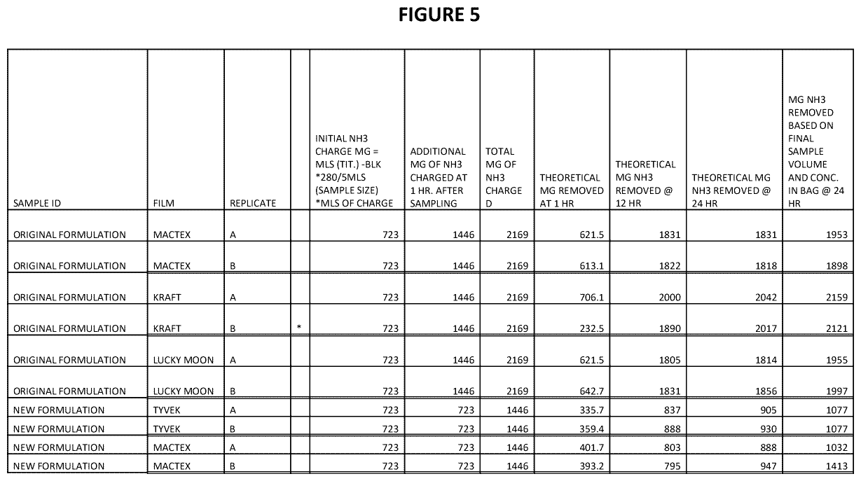

After 24 hours, the amount of ammonia removed by the package containing the ammonia removing composition was calculated by measuring the concentration of the ammonia gas remaining in the flask. The results of the measurements and calculations are provided in FIG. 5 as Replicate A.

Additionally, a theoretical amount of ammonia removed (e.g., adsorbed or absorbed) by the ammonia removing composition was calculated for 1 hour after sampling, 12 hours after sampling, and 24 hours after sampling. Additionally, a theoretical total amount of ammonia adsorbed based on a final sample volume after 24 hours was also calculated. The results of the measurements and calculations are provided in FIG. 5 as Replicate A.

The measurements and calculations of a second sample as described in Example 1 were repeated. The results of the measurements and calculations are provided in FIG. 5 as Replicate B.

### Example 2

A package containing an ammonia removing composition was prepared according to the embodiments disclosed herein.

The ammonia removing composition was prepared as a powder mixture. The amount of the powder mixture was about 15 grams. The formulation of the powder mixture was about 50% carbon and about 50% zeolite.

The powder mixture was sealed within a Kraft package.

A flask containing a measured amount of ammonia gas (NH₃) was prepared. The initial amount of ammonia gas in the flask was 723 mg (e.g., initial ammonia gas charge). The package containing the ammonia removing composition was inserted inside the flask. After one hour, an additional amount of 1446 mg of ammonia gas was inserted inside the flask (e.g., additional ammonia gas charge).

After 24 hours, the amount of ammonia removed by the package containing the ammonia removing composition was calculated by measuring the concentration of the ammonia gas remaining in the flask. The results of the measurements and calculations are provided in FIG. 5 as Replicate A.

Additionally, a theoretical amount of ammonia removed (e.g., adsorbed or absorbed) by the ammonia removing composition was calculated for 1 hour after sampling, 12 hours after sampling, and 24 hours after sampling. Additionally, a theoretical total amount of ammonia adsorbed based on a final sample volume after 24 hours was also calculated. The results of the measurements and calculations are provided in FIG. 5 as Replicate A.

The measurements and calculations of a second sample as described in Example 2 were repeated. The results of the measurements and calculations are provided in FIG. 5 as Replicate B.

### Example 3

A package containing an ammonia removing composition was prepared according to the embodiments disclosed herein.

The ammonia removing composition was prepared as a powder mixture. The amount of the powder mixture was about 15 grams. The formulation of the powder mixture was about 50% carbon and about 50% zeolite.

The powder mixture was sealed within a Lucky Moon package.

A flask containing a measured amount of ammonia gas (NH₃) was prepared. The initial amount of ammonia gas in the flask was 723 mg (e.g., initial ammonia gas charge). The package containing the ammonia removing composition was inserted inside the flask. After one hour, an additional amount of 1446 mg of ammonia gas was inserted inside the flask (e.g., additional ammonia gas charge).

After 24 hours, the amount of ammonia removed by the package containing the ammonia removing composition was calculated by measuring the concentration of the ammonia gas remaining in the flask. The results of the measurements and calculations are provided in FIG. 5 as Replicate A.

Additionally, a theoretical amount of ammonia removed (e.g., adsorbed or absorbed) by the ammonia removing composition was calculated for 1 hour after sampling, 12 hours after sampling, and 24 hours after sampling. Additionally, a theoretical total amount of ammonia adsorbed based on a final sample volume after 24 hours was also calculated. The results of the measurements and calculations are provided in FIG. 5 as Replicate A.

The measurements and calculations of a second sample as described in Example 3 were repeated. The results of the measurements and calculations are provided in FIG. 5 as Replicate B.

### Example 4

A package containing an ammonia removing composition was prepared according to the embodiments disclosed herein.

The ammonia removing composition was prepared as a powder mixture. The amount of the powder mixture was about 15 grams. The formulation of the powder mixture was about 60% carbon and about 40% zeolite.

The powder mixture was sealed within a Tyvek package.

A flask containing a measured amount of ammonia gas (NH₃) was prepared. The initial amount of ammonia gas in the flask was 723 mg (e.g., initial ammonia gas charge). The package containing the ammonia removing composition was inserted inside the flask. After one hour, an additional amount of 723 mg of ammonia gas was inserted inside the flask (e.g., additional ammonia gas charge).

After 24 hours, the amount of ammonia removed by the package containing the ammonia removing composition was calculated by measuring the concentration of the ammonia gas remaining in the flask. The results of the measurements and calculations are provided in FIG. 5 as Replicate A.

Additionally, a theoretical amount of ammonia removed (e.g., adsorbed or absorbed) by the ammonia removing composition was calculated for 1 hour after sampling, 12 hours after sampling, and 24 hours after sampling. Additionally, a theoretical total amount of ammonia adsorbed based on a final sample volume after 24 hours was also calculated. The results of the measurements and calculations are provided in FIG. 5 as Replicate A.

The measurements and calculations of a second sample as described in Example 4 were repeated. The results of the measurements and calculations are provided in FIG. 5 as Replicate B.

### Example 5

A package containing an ammonia removing composition was prepared according to the embodiments disclosed herein.

The ammonia removing composition was prepared as a powder mixture. The amount of the powder mixture was about 15 grams. The formulation of the powder mixture was about 60% carbon and about 40% zeolite.

The powder mixture was sealed within a MACTEX package.

A flask containing a measured amount of ammonia gas (NH₃) was prepared. The initial amount of ammonia gas in the flask was 723 mg (e.g., initial ammonia gas charge). The package containing the ammonia removing composition was inserted inside the flask. After one hour, an additional amount of 723 mg of ammonia gas was inserted inside the flask (e.g., additional ammonia gas charge).

After 24 hours, the amount of ammonia removed by the package containing the ammonia removing composition was calculated by measuring the concentration of the ammonia gas remaining in the flask. The results of the measurements and calculations are provided in FIG. 5 as Replicate A.

Additionally, a theoretical amount of ammonia removed (e.g., adsorbed or absorbed) by the ammonia removing composition was calculated for 1 hour after sampling, 12 hours after sampling, and 24 hours after sampling. Additionally, a theoretical total amount of ammonia adsorbed based on a final sample volume after 24 hours was also calculated. The results of the measurements and calculations are provided in FIG. 5 as Replicate A.

The measurements and calculations of a second sample as described in Example 5 were repeated. The results of the measurements and calculations are provided in FIG. 5 as Replicate B.

As shown in the results in FIG. 5, the ammonia removing composition used in Examples 1-3 had a greater amount of charged ammonia and a higher theoretical removal (e.g., adsorption or absorption) amount of ammonia than the ammonia removing composition used in Examples 4 and 5. All examples did remove ammonia from the flask.

What is claimed is:

1. A chemical removing element comprising a sealed sachet containing a chemical removing composition, the chemical removing composition comprising carbon and zeolite,
wherein the chemical removing composition is configured to remove ammonia-like chemicals having one or more covalent bonds among smaller numbers of atoms from an environment surrounding the chemical removing element.

2. The chemical removing element of claim 1, wherein the chemical removing composition comprises about 50% by weight of the chemical removing composition is carbon and about 50% by weight of the chemical removing composition is zeolite.

3. The chemical removing element of claim 1, wherein the chemical removing composition comprises about 60% by weight of the chemical removing composition is carbon and about 40% by weight of the chemical removing composition is zeolite.

4. The chemical removing element of claim 1, wherein the carbon comprises coal-based powder.

5. The chemical removing element of claim 1, wherein the zeolite comprises Natural Sodium Chabazite (AZLB-Na).

6. The chemical removing element of claim 1, wherein the chemical it is configured to remove comprises at least one of ammonia, hydrocarbons having 1 to 3 carbon atoms, ketones, or alcohols.

7. The chemical removing element of claim 6, wherein the chemical it is configured to remove comprises ethylene.

8. A chemical removing element comprising a sealed sachet containing a chemical removing composition, the chemical removing composition comprising carbon and sodium bentonite clay,
wherein the chemical removing composition is configured to remove ammonia-like chemicals having one or more covalent bonds among smaller numbers of atoms from an environment surrounding the chemical removing element.

9. The chemical removing element of claim 8, wherein the chemical removing composition comprises about 50% by weight of the chemical removing composition is carbon and about 50% by weight of the chemical removing composition is sodium bentonite clay.

10. The chemical removing element of claim 8, wherein the chemical removing composition comprises about 60% by weight of the chemical removing composition is carbon and about 40% by weight of the chemical removing composition is sodium bentonite clay.

11. The chemical removing element of claim 8, wherein the carbon comprises coal-based powder.

12. The chemical removing element of claim 8, wherein the chemical it is configured to remove comprises at least one of ammonia, hydrocarbons having 1 to 3 carbon atoms, ketones, or alcohols.

13. The chemical removing element of claim 12, wherein the chemical it is configured to remove comprises ethylene.

14. A system for removing chemicals comprising:
a chemical removing element comprising a sealed sachet containing a chemical removing composition; and
a plant product,
wherein the chemical removing composition is configured to remove ammonia-like chemicals having one or more covalent bonds among smaller numbers of atoms from an environment surrounding the chemical removing element.

15. The system for removing chemicals of claim 14, wherein the chemical removing composition comprises carbon and zeolite.

16. The system for removing chemicals of claim 15, wherein the chemical removing composition comprises about 50% by weight of the chemical removing composition is carbon and about 50% by weight of the chemical removing composition is zeolite.

17. The system for removing chemicals of claim 15, wherein the chemical removing composition comprises about 60% by weight of the chemical removing composition is carbon and about 40% by weight of the chemical removing composition is zeolite.

18. The system for removing chemicals of claim 15, wherein the carbon comprises coal-based powder.

19. The system for removing chemicals of claim 15, wherein the zeolite comprises Natural Sodium Chabazite (AZLB-Na).

20. The system for removing chemicals of claim 14, wherein the chemical removing composition comprises carbon and sodium bentonite clay.

21. The system for removing chemicals of claim 20, wherein the chemical removing composition comprises about 50% by weight of the chemical removing composition is carbon and about 50% by weight of the chemical removing composition is sodium bentonite clay.

22. The system for removing chemicals of claim 20, wherein the chemical removing composition comprises about 60% by weight of the chemical removing composition is carbon and about 40% by weight of the chemical removing composition is sodium bentonite clay.

23. The system for removing chemicals of claim 20, wherein the carbon comprises coal-based powder.

24. The system for removing chemicals of claim 14, wherein the plant product comprises a tobacco product.

25. The chemical removing element of claim 14, wherein the chemical it is configured to remove comprises at least one of ammonia, hydrocarbons having 1 to 3 carbon atoms, ketones, or alcohols.

26. The chemical removing element of claim 25, wherein the chemical it is configured to remove comprises ethylene.

27. A method for forming a chemical removing element, the method comprising:
preparing a chemical removing composition;
adding the chemical removing composition to a sachet; and
sealing the sachet,
wherein the chemical removing composition is configured to remove chemicals from an environment surrounding the chemical removing element, and
wherein the chemical the composition is configured to remove comprises at least one of ammonia, hydrocarbons having 1 to 3 carbon atoms, ketones, or alcohols.

28. The method of claim 27, wherein the chemical removing composition comprises carbon and zeolite.

29. The method of claim 28, wherein the chemical removing composition comprises about 50% by weight of the chemical removing composition is carbon and about 50% by weight of the chemical removing composition is zeolite.

30. The method of claim 28, wherein the chemical removing composition comprises about 60% by weight of the chemical removing composition is carbon and about 40% by weight of the chemical removing composition is zeolite.

31. The method of claim 28, wherein the carbon comprises coal-based powder.

32. The method of claim 28, wherein the zeolite comprises Natural Sodium Chabazite (AZLB-Na).

33. The method of claim 27, wherein the chemical removing composition comprises carbon and sodium bentonite clay.

34. The method of claim 33, wherein the chemical removing composition comprises about 50% by weight of the chemical removing composition is carbon and about 50% by weight of the chemical removing composition is sodium bentonite clay.

35. The method of claim 33, wherein the chemical removing composition comprises about 60% by weight of the chemical removing composition is carbon and about 40% by weight of the chemical removing composition is sodium bentonite clay.

36. The method of claim 33, wherein the carbon comprises coal-based powder.

37. The method of claim 27, wherein the chemical the composition is configured to remove comprises ethylene.
